(19) United States
(12) Patent Application Publication
(10) Pub. No.: US 2023/0041173 A1
(43) Pub. Date: Feb. 9, 2023

(54) Reclinable Therapeutic Massage Chair

(71) Applicant: ERGO-FLEX TECHNOLOGIES, LLC, Conroe, TX (US)

(72) Inventors: J.T. Anderson, Conroe, TX (US); Linda C. Anderson, Conroe, TX (US)

(73) Assignee: ERGO-FLEX TECHNOLOGIES, LLC, Conroe, TX (US)

(21) Appl. No.: 17/887,005

(22) Filed: Aug. 12, 2022

Related U.S. Application Data
(63) Continuation-in-part of application No. 16/656,174, filed on Oct. 17, 2019, now Pat. No. 11,458,060.
Application No. 16/656,174 is a continuation of application No. 14/750,323, filed on Jun. 25, 2015, now Pat. No. 10,478,367.
Application No. 14/750,323 is a continuation of application No. 13/438,515, filed on Apr. 3, 2012, now abandoned.

(51) Int. Cl. A61H 1/00; A61H 1/02; A47C 1/024

(52) U.S. Cl. CPC A61H 1/008; A61H 1/02; A61H 1/0229; A61H 1/0244; A61H 1/0292; A47C 1/024; A61H 2201/0207; A61H 2201/1676; A61H 2201/5097; A61H 2201/1664; A61H 2201/1669; A61H 23/02

(57) ABSTRACT

A therapeutic massage chair is reclinable between a horizontal and inclined position. The chair includes an upper back support member and a lower support member that is axially movable along a support frame, and is also rotatable about an axis which is perpendicular to the plane of the upper back support member. Electric linear actuators are provided to recline the therapeutic massage chair, and both axially move and oscillate the lower body support member. The therapeutic massage chair may be fitted with a controller system which allows the chair to be operated wirelessly from a mobile device running a mobile application, which may communicate with a web-based portal and/or database.

### CROSS-REFERENCE TO RELATED APPLICATIONS

This application is a continuation-in-part of U.S. patent application Ser. No. 16/656,174 filed Oct. 17, 2019, which is a continuation of U.S. patent application Ser. No. 14/750,323 filed Jun. 25, 2015, which is a continuation of U.S. application Ser. No. 13/438,515 filed on Apr. 3, 2012, each of which are incorporated herein by reference thereto in their entirety.

### STATEMENT REGARDING FEDERALLY SPONSORED RESEARCH OR DEVELOPMENT

Not applicable.

### BACKGROUND OF THE INVENTION

### Field of the Invention

This invention is directed to a reclinable chair for use in the alleviation of back pain. The chair may be used by Chiropractors as part of their treatment of clients in an office environment or may be used by individuals at home for example.

### Background of the Invention

Several devices have been proposed for use as treatment apparatus for pain but few have been commercially successful due to their high cost and complexity. Examples of such reclinable chairs are disclosed in U.S. Pat. Nos. 7,654,974; 7,341,565; and 6,277,141. These devices are cumbersome to use and are quite uncomfortable.

### BRIEF SUMMARY OF SOME OF THE PREFERRED EMBODIMENTS

The present invention is a relatively inexpensive and comfortable back pain treatment device designed for use in either a home or office environment. A cushioned chair is tillable from a horizontal position to an inclined orientation. The chair includes a back support portion and a second lower back, upper leg and lower leg support section that is movable in a first axial direction with respect to the back support section and is also arcuately movable about a pivot axis that is perpendicular to the axial direction. The chair includes remotely controlled linear actuators to control the relative movement of the different sections of the device, and may also include heaters and vibrators for additional therapeutic treatment. The chair may be fitted with a controller system which allows the chair to be operated wirelessly from a mobile device running a mobile application, which may communicate with a web-based portal and/or database.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a perspective view of an embodiment of the invention showing the chair in an inclined position;

FIG. 2 illustrates a perspective view of the embodiment of FIG. 1 showing the chair in a horizontal position;

FIG. 3 illustrates perspective view of an embodiment of the reciprocating and oscillating mechanism for the lower portion of the chair;

FIG. 4 illustrates detailed showing of an embodiment of the pivoting mechanism of the lower portion of the chair;

FIG. 5 illustrates perspective view of a portion of the support frame for an embodiment of the lower portion of the chair;

FIG. 6 illustrates a block diagram of a controller system for controlling operation of the chair;

FIG. 7 illustrates an embodiment of calibration process for calibrating operation of the chair;

FIG. 8 illustrates an embodiment of protocol ready function for readying the chair for performing one or more protocols for operating the chair;

FIG. 9 illustrates an embodiment of protocol completion function for completing performance of one or more protocols for operating the chair;

FIG. 10 illustrates a first example embodiment protocol for operating the chair;

FIG. 11 illustrates a second example embodiment protocol for operating the chair;

FIG. 12 illustrates a third example embodiment protocol for operating the chair;

FIG. 13 illustrates a fourth example embodiment protocol for operating the chair;

FIG. 14 illustrates a fifth example embodiment protocol for operating the chair;

FIG. 15 illustrates a sixth example embodiment protocol for operating the chair;

FIG. 16 illustrates a seventh example embodiment protocol for operating the chair;

FIG. 17 illustrates a eighth example embodiment protocol for operating the chair; and

FIG. 18 illustrates a ninth example embodiment protocol for operating the chair.

### DETAILED DESCRIPTION OF THE PREFERRED EMBODIMENTS

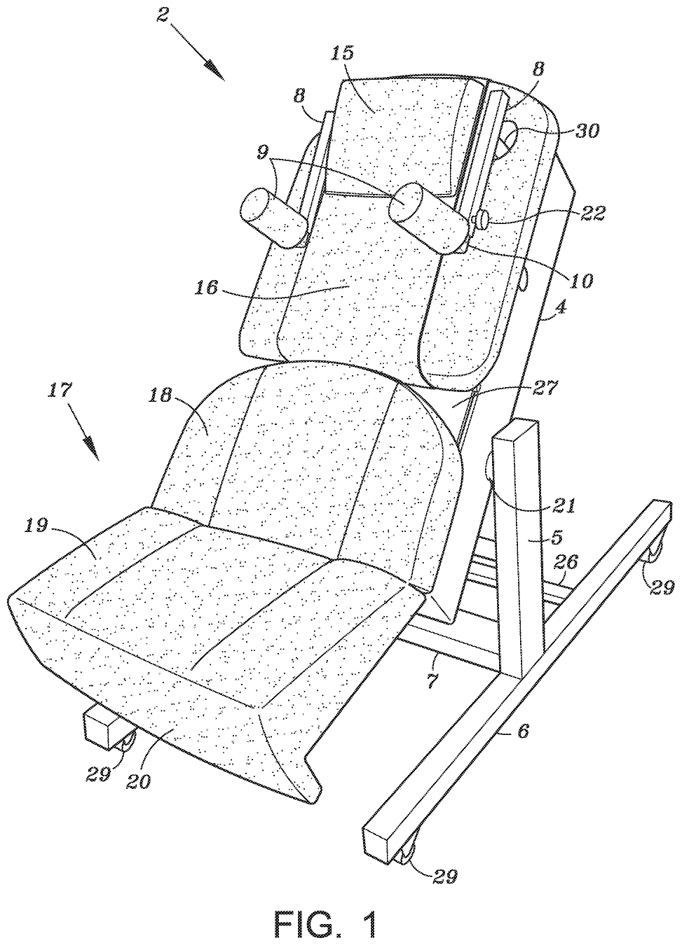

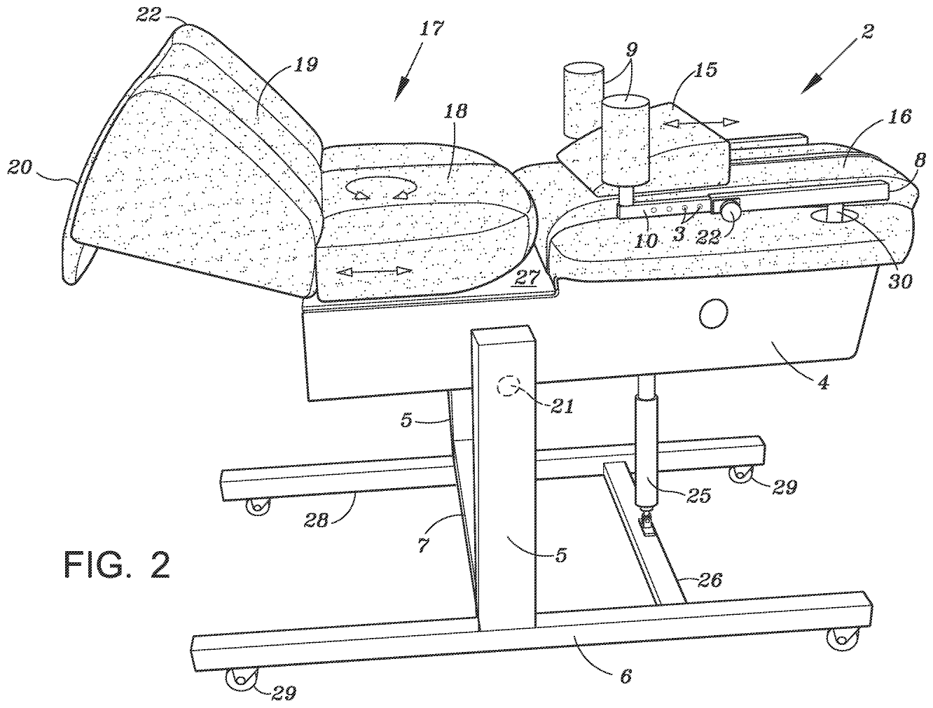

Referring to FIG. 1, the chair 2 of an embodiment of the invention includes a chair support frame 4 that is pivotably attached at 21 to a floor support assembly that includes vertical support posts 5. The floor support assembly for chair frame member 4 includes two parallel horizontal members 6 and 28, a cross support 7, and two vertical support posts 5, as more clearly shown in FIG. 2.

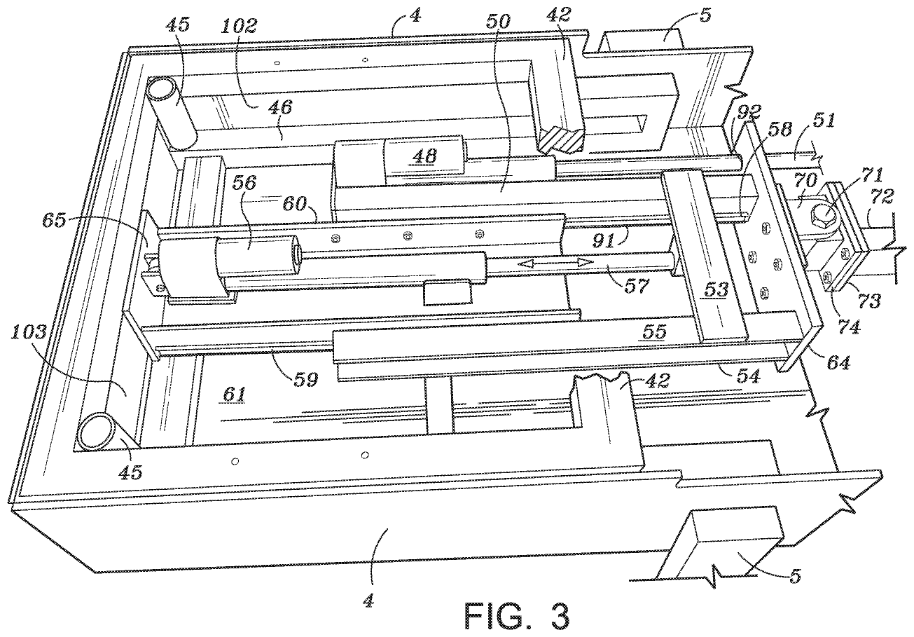

Horizontal support members 6 and 28 may have suitable castors 29 on their outer ends. Referring again to FIG. 1, chair 2 further includes an upper back support 16 secured to chair support frame 4. A head rest portion 15 may be provided for upper back support 16. A pair of cylindrical cushions 9 are attached to the frame 4 by supports 8 and tubes 30 that fit within sockets 45 shown in FIG. 3. Cylindrical cushions 9 extend outwardly from supports 8 and are adapted to be located at the arm pits of a user. The length of the supports 8 may be adjusted by telescoping members 10 that slide within supports 8 and are lockable by a pin or detent 22 and holes 3 as is known in the art. Upper back support 16 may be formed as a cushion supported by a planar member attached to frame 4. Frame 4 includes a bottom closure 61.

Chair 2 also includes a lower body support member 17 that has three support sections 18, 19, and 20 integrally formed together as a unit. Surface 18 is adapted to support the lower back portion of a user, surface 19 supports the upper thighs of a user and surface 20 conforms to the lower legs beneath the knees. In use, the back of a user's knees will be located at point 22 of the lower support member. Lower body support member 17 is secured to a platform 27 which is mounted for reciprocal and oscillatory motion as will be explained later. As shown in FIG. 2, an electric linear actuator 25 is mounted on a cross support member 26 and extends to box frame 4 for pivoting the chair about pivot point 21 shown in FIG. 1.

The internal mechanism for extending and retracting lower body support member with respect to box frame 4 will now be discussed with reference to FIG. 3. A carriage member 50 is slidably supported on shaped track supports 59 that are attached to a stationary frame 60 which is secured to box frame 4. Box frame 4 includes an upper and lower rectangular frames 42 and 46 as well as side walls 102 and 103.

Stationary frame 60 includes a front wall portion 65 to which an electric linear actuator 56 including extension rod 57 is secured. The end of the extension rod 57 is attached to a cross beam 53 of the carriage member 50. Carriage member 50 includes upper and lower elongated plates 55 and 54 on each side and vertical plate members 91 extending between plates 55 and 54 on each side of the carriage. These plates are welded together and to an end plate 64. Each inner surface of vertical plate members 91 carries a longitudinally extending track member 58 which slides along a complimentary shaped track support 59 attached to the outer vertical surface of stationary frame 60. In this manner, as extension rod 57 of linear actuator 56 is extended or retreated, carriage member 50 will move accordingly.

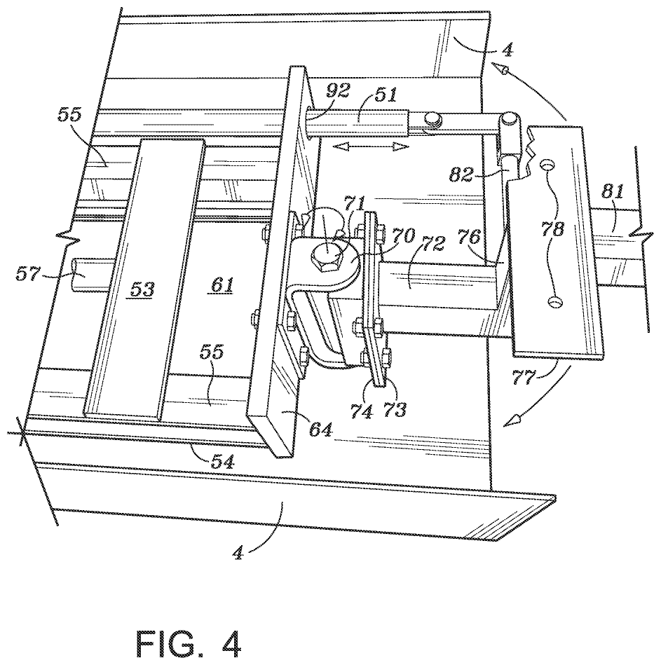

Referring now to FIGS. 3 and 4, a pivot support bracket 70 is rigidly attached to end plate 64 of carriage member 50. Pivot support bracket 70 includes a pivot pin 71. A flange plate 74 is rotatably secured within bracket 70 by pin 71. The lower body support 17 includes a first rectangular tube portion 72, a second rectangular tube portion 76 extending vertically above tube portion 72 and a third rectangular tube portion 81 extending generally parallel to tube portion 72. A flat mounting plate 77 rests atop the junction of tubes 76 and 81. Plate 77 includes a pair of apertures 78 for securing platform 27 thereto. A second flange plate 73 is secured to tube portion 72 and to flange plate 74 so that support assembly 72, 76, 81, and 77 pivots about pin 71. End plate 64 is provided with an aperture 92 through which linear actuator rod 51 extends. An electric linear actuator 48 and rod 51 is supported by and carried with carriage member 50, as seen in FIG. 3.

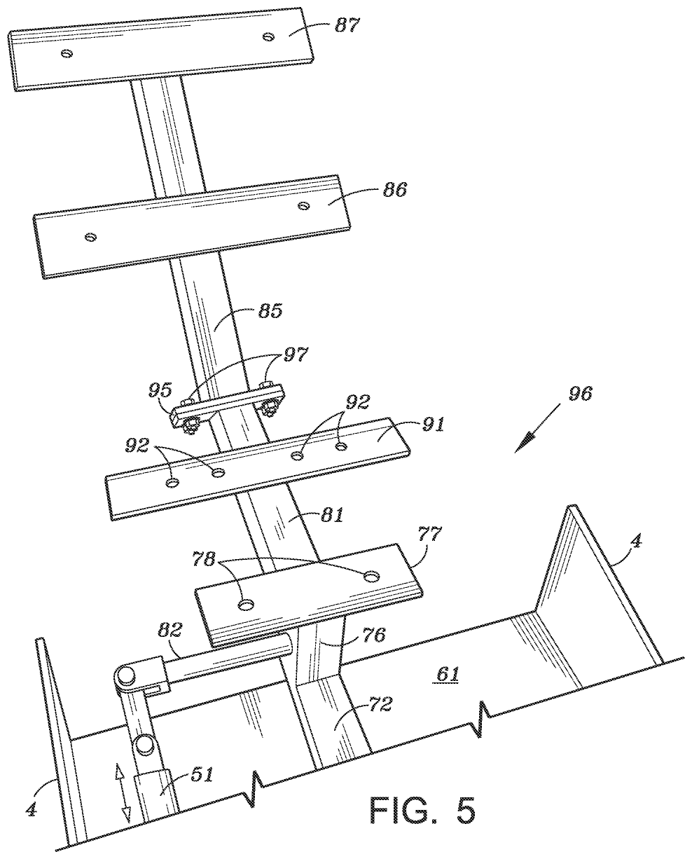

As shown in FIG. 5, frame member 81 supports a plate member 91 having apertures 92 for securing the lower portion of the chair to the frame. Member 81 has a flange 96 at its end for attachment to a further frame member 85 via a second flange 95. Bolts 97 may be used to secure the flanges together.

Frame member 85 extends upwardly at an angle from frame member 81. As shown in FIG. 5, a pair of support plates 86, 87 with suitable apertures are mounted on frame member 85 to support lower body member portion 19. Also, a crank arm 82 is attached at one end to extension rod 51 and at its other end to support 76 in order to oscillate the lower support frame 96 about pivot pin 71.

The chair may be equipped with vibrators at various locations and also with heaters in any convenient location. Also, a hand held wireless remote control or a wired controller may be used to control the various electronic elements of the chair including the vibrators, heaters, and electric linear actuators as known in the art. Electronic timers may also be included in the electronics to control the duration of the devices.

In use, a user may either lie horizontally on the chair in the position shown in FIG. 2 or begin by sitting in the chair in the position shown in FIG. 1.

In either instance, the upper back of the user would be positioned along support section 16 of the chair. The user's lower back would be supported by section 18 of the chair. The user's legs would be supported at the thighs by section 19 and the lower legs would be supported by section 20.

Lower body support member 17 including sections 18, 19, and 20 can be moved back and forth as shown in FIG. 2 relative to upper back support 16. This will gently massage and exercise the muscles as necessary. When support member 17 is moved to the left in FIG. 2, it may then be oscillated about pivot 71 to laterally move and exercise the lumbar and hip region of the back. While in the upright position shown in FIG. 1, cylindrical cushions 9 may be positioned under the user's arm pits to support the upper body while the lower support 17 is moved downwardly so as to enable the user's lower back muscles to be massaged and exercised. Lower support 17 may also be oscillated about pivot 71 in this position.

In the description that follows, the terms “therapeutic apparatus” or “therapeutic apparatuses” are used to refer to one or more reclinable therapeutic massage chairs of the present invention.

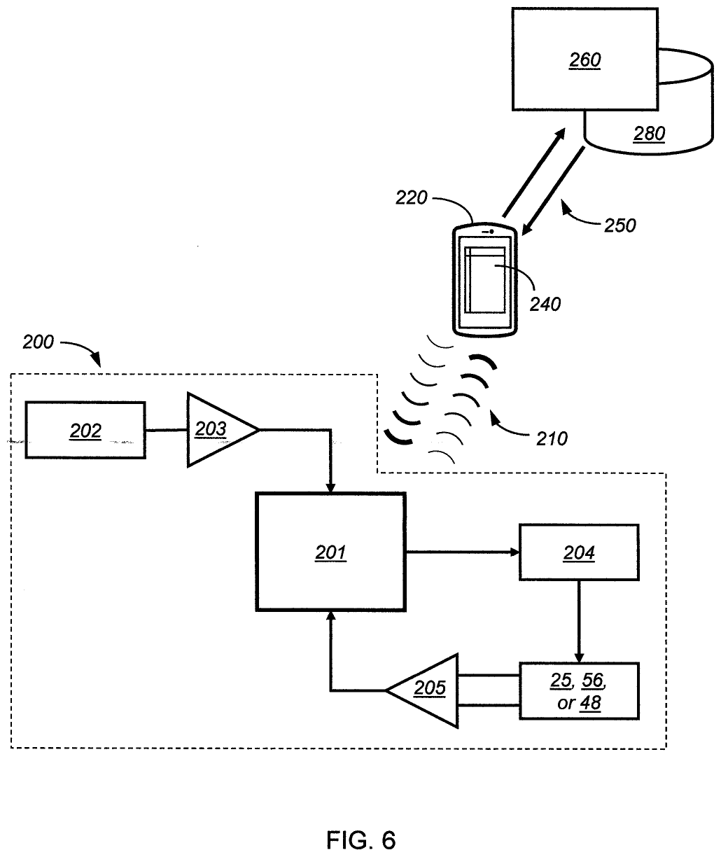

Referring now to FIG. 6, the therapeutic apparatus disclosed herein may be fitted with controller system 200. Controller system 200 may comprise one or more components which may include, but not be limited to, a power supply (not shown), microcontroller 201, one or more load cells 202, one or more load cell amplifiers 203, one or more motor drivers 204, and one or more position feedback systems 205, any of which may be disposed within a housing which may be secured to the therapeutic apparatus, and which may be disposed in a location readily accessible to a person operating or using the therapeutic apparatus. In an embodiment, controller system 200 may be built, formed, assembled, or tested in accordance with, or in order to obtain, one or more certifications, for example UL, CE, or FDA certification. In embodiments of the therapeutic apparatus comprising controller system 200, load cell 202 may be in communication with load cell amplifier 203, load cell amplifier 203 may be in communication with microcontroller 201, microcontroller 201 may be in communication with the one or more motor drivers 204, the one or more motor drivers 204 may be in communication with linear actuator 25, 56, or 48, linear actuator 25, 56, or 48 may be in communication with one or more position feedback systems 205, and the one or more position feedback systems 205 may be in communication with microcontroller 201. In embodiments, the method of each communication between the components just described may be electrical, mechanical, or other suitable form of communication.

Controller system 200 may be capable of being remotely operated, which may allow one or more parameters of operation of the therapeutic apparatus to be varied individually or in one or more sequences or protocols. In embodiments, controller system 200 may communicate with mobile device 220 via a suitable short-range wireless networking medium 210, for example a Bluetooth® short-range wireless network. Mobile device 220 may communicate with web portal 260 and/or database 280 via a suitable network communications medium 250, which may comprise a wired or wireless network communications medium, or combinations thereof. Mobile application 240 may be installed on, and operate from, mobile device 220, and may be in communication with controller system 200 via short-range wireless networking medium 210, and may communicate with web portal 260 and/or database 280 via network communications medium 250. In embodiments, mobile device 220 may be any device capable of mobility on which mobile application 240 may be installed, for example mobile device 220 may be a mobile phone, a smart phone, a tablet computer, a laptop computer, or other suitable mobile device.

The one or more parameters which may be varied by controller system 200 may include, without limitation, a length of extension of linear actuator 25, a length of extension of linear actuator 56, a length of extension of linear actuator 48 (which, in embodiments, may relate to a direction and/or angle of rotation of lower body support member 17 about pivot 71), a duration of time during which the linear force may be applied or the length of extension may be held, a magnitude or duration of vibration or heat being delivered by the therapeutic apparatus, a number of cycles through which one or more parameters may be repeatedly varied, or combinations thereof. In embodiments, one or more such parameters may be provided as a predetermined, desired, or prescribed parameter.

In embodiments, a parameter defining the length of extension of linear actuator 25, 56, or 48 may comprise a range of lengths bounded by a minimum value and a maximum value. For example, the length of extension may comprise a range of lengths between a minimum length, measuring zero inches from a point of reference located on, or in proximity to, the linear actuator, to a maximum length, or maximum position, measuring ten inches from the point of reference located on, or in proximity to, the linear actuator. In different exemplary embodiments, the length of extension may comprise a range between zero inches and two inches, between zero inches and four inches, between zero inches and six inches, between zero inches and eight inches, or between zero inches and ten inches. In embodiments, a length of extension of linear actuator 25, 56, or 48 may be defined as a “home” position, which may comprise a predetermined or desired length of extension, and which may server as a reference length of extension in operation. In embodiments, a “traction” of a linear actuator may correspond to an extension of a length of the linear actuator along its longitudinal axis, while “retracting” the linear actuator may correspond to a change in length of extension in an opposite direction along its longitudinal axis.

In embodiments, the length of extension of linear actuator 48 may relate to an angle of pivot of lower body support member 17 about pivot 71, which may comprise a range of angles bounded by a minimum value and a maximum value, or a range of angles defined by an angle of rotation in combination with a direction from a longitudinal point of reference. For example, the angle of pivot may range from 45 degrees to 135 degrees, wherein an angle of 90 degrees may correspond to lower body support member 17 being positioned in a centrally aligned orientation, or a “home” position, such that a longitudinal axis of lower body support member 17 is in alignment with a longitudinal axis of upper back support 16. In this manner, an angle of pivot of 45 degrees may comprise an angle of 45 degrees from a centrally aligned orientation of lower body support member 17 in a first direction, while an angle of pivot of 135 degrees may comprise an angle of 45 degrees from a centrally aligned orientation of lower body support member 17 in a second direction which is opposite of the first direction. In other exemplary embodiments, differing lengths of extension of linear actuator 48 may cause lower body support member 17 to rotate about pivot 71 in a range of 10 degrees left to 10 degrees right, 20 degrees left to 20 degrees right, 30 degrees left to 30 degrees right or 45 degrees left to 45 degrees right.

In embodiments, a parameter defining the duration of time during which the linear force may be applied or the length of extension may be held may comprise a range of durations bounded by a minimum value and a maximum value. For example, the duration may comprise a range between zero seconds to a maximum of 1,800 seconds (thirty minutes) or longer. In different exemplary embodiments, the duration may comprise a range between zero seconds and 120 seconds, between zero seconds and 240 seconds, between zero seconds and 360 seconds, between zero seconds and 420 seconds, between zero seconds and 480 seconds, between zero seconds and 600 seconds, between zero seconds and 1,200 seconds, or between zero and 1,800 seconds.

Controller system 200 may be configurable to perform one or more calibration processes, for example to calibrate a length of extension of linear actuator 25, 56, or 48 (or a pivot angle related thereto).

In an embodiment, the one or more calibration processes may comprise calibrating the length of extension of linear actuator 25, 56, or 48 to one or more known or observed measures of length, which may be provided by, or set by, a person initiating or observing the calibration process. For example, controller system 200 may calibrate the length of extension based upon configuring linear actuator 25, 56, or 48 in a first position, which controller system 200 may be set to recognize as a minimum extended position, and separately configuring linear actuator 25, 56, or 48 in a second, extended position, which controller system 200 may be set to recognize as a maximum extended position. In embodiments, the first and second positions may each correspond to a measure of length from one or more reference points located about the therapeutic apparatus, or one or more components thereof, and controller system 200 may be configured to recognize each position based on a unit of measure of length from the one or more reference points, within an acceptable margin of error. In this manner, when controller system 200 may be executing a protocol directing that linear actuator 25, 56, or 48 be extended to a predetermined or desired length of extension, or a predetermined or desired percentage of extension, controller system 200 will be calibrated so as to extend linear actuator 25, 56, or 48 to the predetermined or desired length of extension within an acceptable margin of error.

In an embodiment, the one or more calibration processes may comprise calibrating the length of extension of linear actuator 48 in reference to one or more known measures of rotational angles of lower body support member 17, or a portion thereof, about pivot 71. In this manner, when controller system 200 may be executing a protocol directing that linear actuator 48 be extended to rotate lower body support member 17 about pivot 71 to a predetermined or desired angle in a predetermined or desired direction, or a predetermined or desired percentage thereof, controller system 200 will be calibrated so as to extend linear actuator 48 to the predetermined or desired length of extension such that lower body support member 17 may rotate about pivot 71 to the predetermined or desired angle and direction within an acceptable margin of error.

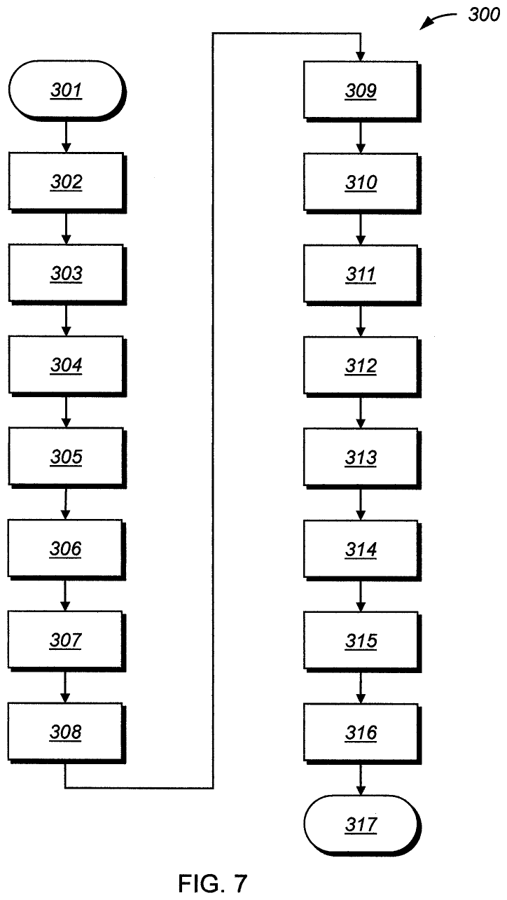

FIG. 7 illustrates an embodiment of calibration process 300, starting at method step 301. Calibration process 300 continues to method steps 302, 303, and 304, where calibration process may cause each linear actuator 48, 56, and 25, respectively, extend or retract to a home position. Upon each linear actuator returning to a home position, calibration process 300 proceeds to calibrate linear actuator 25, first by retracting linear actuator 25 to a minimum position at method step 305, then by extending linear actuator 25 to a maximum position at method step 306, and concluding by retracting linear actuator a predetermined length, for example 1 to 4 inches at method step 307. Calibration process 300 next proceeds to calibrate linear actuator 56, first by retracting linear actuator 56 to a minimum position at method step 308, then by extending linear actuator 56 to a maximum position at method step 309, and concluding by returning linear actuator 56 to the home position at method step 310. Calibration process 300 then proceeds to calibrate linear actuator 48, first be extending linear actuator 56 to a maximum position at method step 311, then by retracting linear actuator 48 to a minimum position at method step 312, followed by extending linear actuator 48 to a maximum position at method step 313, and concluding by returning linear actuator 48 to the home position at method step 314. Calibration process 300 then concludes by returning linear actuator 56 to the home position at method step 315, and returning linear actuator 25 to the home position at method step 316, with calibration process 300 then ending at method step 317.

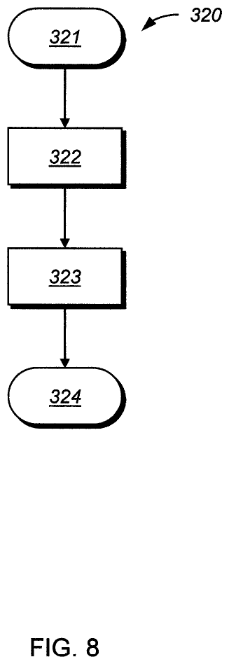

FIG. 8 illustrates an embodiment of protocol ready function 320, starting at method step 321. Protocol ready function 320 continues to method step 322, where protocol ready function 320 may cause linear actuator 25 to transition to a protocol home position, which may comprise a home position specific to a protocol. The method then proceeds to method step 323, at which point protocol ready function 320 may pause, or hold linear actuator 25 at the protocol home position for a predetermined duration, for example 15 seconds, followed by protocol ready function 320 ending at method step 324.

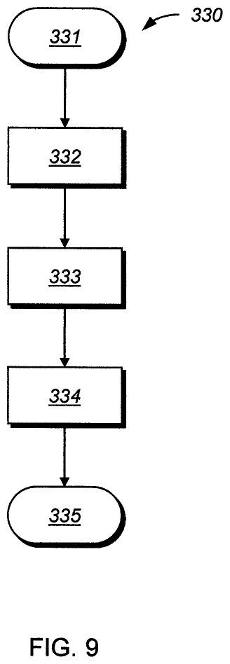

FIG. 9 illustrates an embodiment of protocol completion function 330, starting at method step 331. Protocol completion function 330 continues to method step 332, where protocol completion function 330 may cause linear actuator 48 to return to a home position, thereby causing lower body support member 17 to rotate about pivot 71 to a centrally aligned orientation, at which point protocol completion function 330 may pause, or hold linear actuator 48 in the home position, for a predetermined duration, for example 5 seconds. Next, protocol completion function 330 proceeds to method step 333, where protocol completion function 330 may cause linear actuator 56 to transition to a home position, at which point protocol completion function 330 may pause, or hold linear actuator 56 at the home position, for a predetermined duration, for example 5 seconds. The method then proceeds to method step 334, at which point protocol completion function 330 may cause linear actuator 25 to transition to a home position, followed by protocol completion function 330 ending at method step 335.

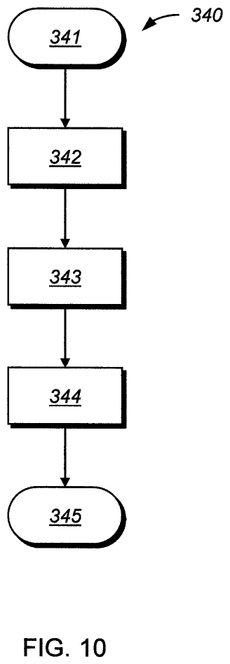

FIG. 10 illustrates a first example embodiment protocol 340, starting at method step 341 and continuing to method step 342, where protocol 340 may cause a protocol ready function to be performed. Protocol 340 continues to method step 343, where protocol 340 may cause linear actuator 56 to traction lower body support member 17 to a full prescribed length of extension, followed by protocol 340 holding linear actuator 56 at the full prescribed length of extension for a prescribed duration. Protocol 340 then concludes by causing a protocol completion function to be performed at method step 344, with protocol 340 then ending at method step 345.

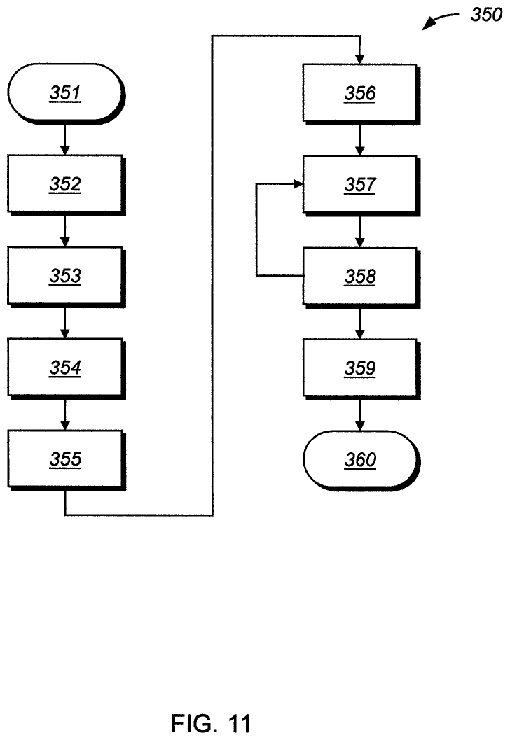

FIG. 11 illustrates a second example embodiment protocol 350, starting at method step 351 and continuing to method step 352, where protocol 350 may cause a protocol ready function to be performed. Protocol 350 continues to method step 353, where protocol 350 may cause linear actuator 56 to traction lower body support member 17 to ⅓rd of a prescribed length of extension, followed by protocol 350 holding linear actuator 56 at this position for a predetermined duration, for example 30 seconds. Next, protocol 350 proceeds to method step 354, where protocol 350 may cause linear actuator 56 to retract lower body support member 17 a predetermined length, for example ½ inch, followed by protocol 350 holding linear actuator 56 at this retracted length for a predetermined duration, for example 10 seconds. Protocol 350 then continues to method step 355, where protocol 350 may cause linear actuator 56 to traction lower body support member 17 to ⅔rds of the prescribed length of extension, followed by protocol 350 holding linear actuator 56 at this position for a predetermined duration, for example 30 seconds. Thereafter, protocol 350 proceeds to method step 356, where protocol 350 may again cause linear actuator 56 to retract lower body support member 17 a predetermined length, for example ½ inch, followed by protocol 350 holding linear actuator 56 at this retracted length for a predetermined duration, for example 10 seconds. Continuing to method step 357, protocol 350 may next cause linear actuator 56 to traction lower body support member 17 to the full prescribed length of extension, followed by protocol 350 holding linear actuator 56 at the full prescribed length of extension for a predetermined duration, for example 30 seconds. Next, protocol 350 continues to method step 358, where protocol 350 may cause linear actuator 56 to retract lower body support member 17 a predetermined length, for example ½ inch, followed by protocol 350 holding linear actuator 56 at this retracted length for a predetermined duration, for example 10 seconds. Method steps 357 through 358 may then be repeated by protocol 350 for a prescribed number of cycles, or for a predetermined duration. Protocol 350 then concludes by causing a protocol completion function to be performed at method step 359, with protocol 350 then ending at method step 360.

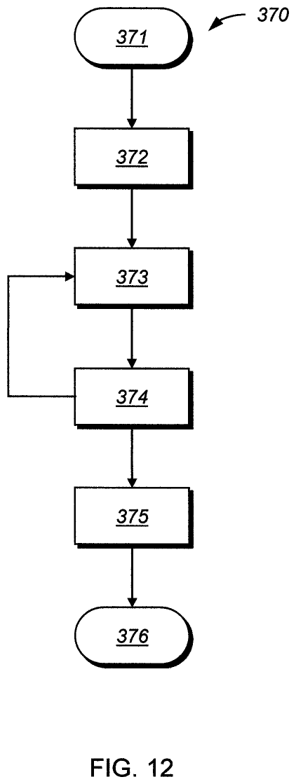

FIG. 12 illustrates a third example embodiment protocol 370, starting at method step 371 and continuing to method step 372, where protocol 370 may cause a protocol ready function to be performed. Protocol 370 continues to method step 373, where protocol 370 may cause linear actuator 56 to traction lower body support member 17 to a full prescribed length of extension, followed by protocol 340 holding linear actuator 56 at the full prescribed length of extension for a predetermined duration, for example 30 seconds. Next, protocol 370 proceeds to method step 374, where protocol 370 may cause linear actuator 56 to retract lower body support member 17 a predetermined length, for example ½ inch, followed by protocol 370 hold linear actuator 56 at this retracted length for a predetermined duration, for example 10 seconds. Method steps 373 through 374 may then be repeated by protocol 370 for a prescribed number of cycles, or for a predetermined duration. Protocol 370 then concludes by causing a protocol completion function to be performed at method step 375, with protocol 370 then ending at method step 376.

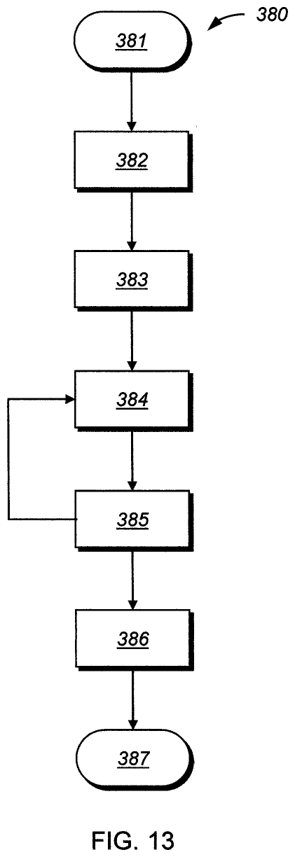

FIG. 13 illustrates a fourth example embodiment protocol 380, starting at method step 381 and continuing to method step 382, where protocol 380 may cause a protocol ready function to be performed. Protocol 380 continues to method step 383, where protocol 380 may cause linear actuator 56 to traction lower body support member 17 to a full prescribed length of extension, followed by protocol 380 holding linear actuator 56 at the full prescribed length of extension for a predetermined duration, for example 30 seconds. Next, protocol 380 proceeds to method step 384, where protocol 380 may cause linear actuator 48 to extend or retract a predetermined length, thereby causing lower body support member 17 to rotate about pivot 71 in a predetermined direction to a predetermined angle, followed by protocol 380 holding linear actuator 48 at the predetermined length, thereby holding lower body support member 17 at the predetermined angle, for a predetermined duration, for example 30 seconds. In alternate embodiments, the predetermined direction may be either left or right, and the predetermined angle may be any angle which linear actuator 48 may rotate lower body support member 17 about pivot 71, for example 10 degrees or 20 degrees. Protocol 380 then continues to method step 385, where protocol 380 may next cause linear actuator 48 to return to a home position, thereby causing lower body support member 17 to rotate about pivot 71 to a centrally aligned orientation, followed by protocol 380 holding linear actuator 48 in the home position for a predetermined duration, for example 30 seconds. Method steps 384 through 385 may then be repeated by protocol 380 for a prescribed number of cycles, or for a predetermined duration. Protocol 380 then concludes by causing a protocol completion function to be performed at method step 386, with protocol 380 then ending at method step 387.

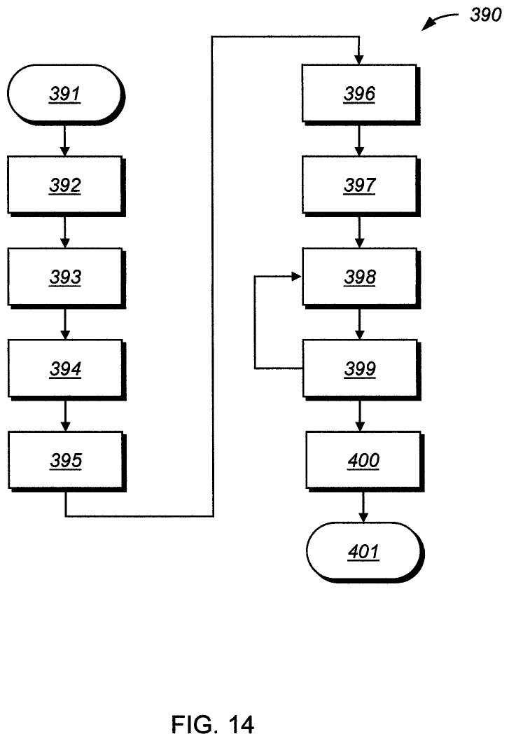

FIG. 14 illustrates a fifth example embodiment protocol 390, starting at method step 391 and continuing to method step 392, where protocol 390 may cause a protocol ready function to be performed. Protocol 390 continues to method step 393, where protocol 390 may cause linear actuator 56 to traction lower body support member 17 to ⅓rd of a prescribed length of extension, followed by protocol 390 holding linear actuator 56 at this position for a predetermined duration, for example 30 seconds. Next, protocol 390 proceeds to method step 394, where protocol 390 may cause linear actuator 48 to extend or retract a predetermined length, thereby causing lower body support member 17 to rotate about pivot 71 in a predetermined direction to a predetermined angle, followed by protocol 390 holding linear actuator 48 at the predetermined length, thereby holding lower body support member 17 at the predetermined angle, for a predetermined duration, for example 30 seconds. In alternate embodiments, the predetermined direction may be either left or right, and the predetermined angle may be any angle which linear actuator 48 may rotate lower body support member 17 about pivot 71, for example 10 degrees or 20 degrees. Protocol 390 then continues to method step 395, where protocol 390 may cause linear actuator 56 to retract lower body support member 17 a predetermined length, for example ½ inch, followed by protocol 390 holding linear actuator 56 at this retracted length for a predetermined duration, for example 10 seconds. Thereafter, protocol 390 proceeds to method step 396, where protocol 390 may cause linear actuator 56 to traction lower body support member 17 to ⅔rds of the prescribed length of extension, followed by protocol 390 holding linear actuator 56 at this position for a predetermined duration, for example 30 seconds. Continuing to method step 397, protocol 390 may cause linear actuator 56 to retract lower body support member 17 a predetermined length, for example ½ inch, followed by protocol 390 holding linear actuator 56 at this retracted length for a predetermined duration, for example 10 seconds. Next, protocol 390 continues to method step 398, where protocol 390 may cause linear actuator 56 to traction lower body support member 17 to the full prescribed length of extension, followed by protocol 390 holding linear actuator 56 at the full prescribed length of extension for a predetermined duration, for example 30 seconds. Proceeding thereafter to method step 399, protocol 390 may cause linear actuator 56 to retract lower body support member 17 a predetermined length, for example ½ inch, followed by protocol 390 holding linear actuator 56 at this retracted length for a predetermined duration, for example 10 seconds. Method steps 398 through 399 may then be repeated by protocol 390 for a prescribed number of cycles, or for a predetermined duration. Protocol 390 then concludes by causing a protocol completion function to be performed at method step 400, with protocol 390 then ending at method step 401.

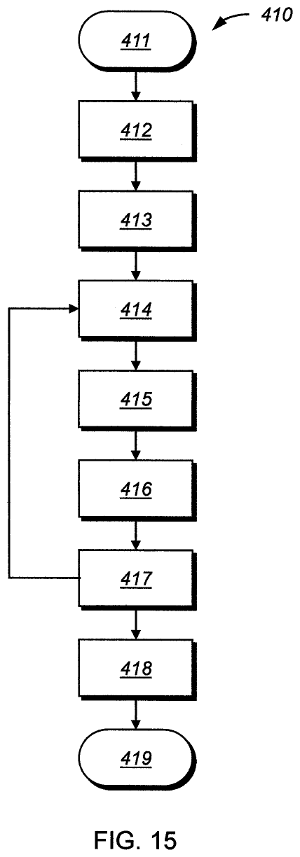

FIG. 15 illustrates a sixth example embodiment protocol 410, starting at method step 411 and continuing to method step 412, where protocol 410 may cause a protocol ready function to be performed. Protocol 410 continues to method step 413, where protocol 410 may cause linear actuator 56 to traction lower body support member 17 to a full prescribed length of extension, followed by protocol 410 holding linear actuator 56 at the full prescribed length of extension for a predetermined duration, for example 30 seconds. Next, protocol 410 proceeds to method step 414, where protocol 410 may cause linear actuator 48 to extend or retract a predetermined length, thereby causing lower body support member 17 to rotate about pivot 71 in a predetermined direction to a predetermined angle, followed by protocol 410 holding linear actuator 48 at the predetermined length, thereby holding lower body support member 17 at the predetermined angle, for a predetermined duration, for example 5 seconds. In alternate embodiments, the predetermined direction may be either left or right, and the predetermined angle may be any angle which linear actuator 48 may rotate lower body support member 17 about pivot 71, for example 10 degrees. Protocol 410 then continues to method step 415, where protocol 410 may next cause linear actuator 48 to return to a home position, thereby causing lower body support member 17 to rotate about pivot 71 to a centrally aligned orientation, followed by protocol 410 holding linear actuator 48 in the home position for a predetermined duration, for example 5 seconds. Thereafter, protocol 410 proceeds to method step 416, where protocol 410 may cause linear actuator 48 to retract or extend a predetermined length, thereby causing lower body support member 17 to rotate about pivot 71 in a predetermined direction to a predetermined angle, followed by protocol 410 holding linear actuator 48 at the predetermined length, thereby holding lower body support member 17 at the predetermined angle, for a predetermined duration, for example 5 seconds. In embodiments, the predetermined direction may be in a direction opposite of the predetermined direction of method step 414, and the predetermined angle may be the same angle as the predetermined angle of method step 414. Continuing to method step 417, protocol 410 may next cause linear actuator 48 to return to a home position, thereby causing lower body support member 17 to rotate about pivot 71 to a centrally aligned orientation, followed by protocol 410 holding linear actuator 48 in the home position for a predetermined duration, for example 5 seconds. Method steps 414 through 417 may then be repeated by protocol 410 for a prescribed number of cycles, or for a predetermined duration. Protocol 410 then concludes by causing a protocol completion function to be performed at method step 418, with protocol 410 then ending at method step 419.

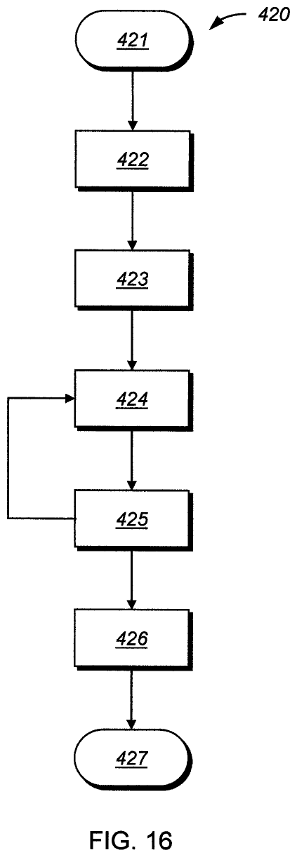

FIG. 16 illustrates a seventh example embodiment protocol 420, starting at method step 421 and continuing to method step 422, where protocol 420 may cause a protocol ready function to be performed. Protocol 420 continues to method step 423, where protocol 420 may cause linear actuator 56 to traction lower body support member 17 to a full prescribed length of extension, followed by protocol 420 holding linear actuator 56 at the full prescribed length of extension for a predetermined duration, for example 5 seconds. Next, protocol 420 proceeds to method step 424, where protocol 420 may cause linear actuator 48 to extend or retract a predetermined length, thereby causing lower body support member 17 to rotate about pivot 71 in a predetermined direction to a predetermined angle, followed by protocol 420 holding linear actuator 48 at the predetermined length, thereby holding lower body support member 17 at the predetermined angle, for a predetermined duration, for example 1-2 seconds. In alternate embodiments, the predetermined direction may be either left or right, and the predetermined angle may be any angle which linear actuator 48 may rotate lower body support member 17 about pivot 71, for example 10 degrees or 20 degrees. Protocol 420 then continues to method step 425, where protocol 420 may cause linear actuator 48 to retract or extend a predetermined length, thereby causing lower body support member 17 to rotate about pivot 71 in a predetermined direction to a predetermined angle, followed by protocol 420 holding linear actuator 48 at the predetermined length, thereby holding lower body support member 17 at the predetermined angle, for a predetermined duration, for example 1-2 seconds. In embodiments, the predetermined direction may be in a direction opposite of the predetermined direction of method step 414, and the predetermined angle may be the same angle as the predetermined angle of method step 414. Method steps 424 through 425 may then be repeated by protocol 420 for a prescribed number of cycles, or for a predetermined duration. Protocol 420 then concludes by causing a protocol completion function to be performed at method step 426, with protocol 420 then ending at method step 427.

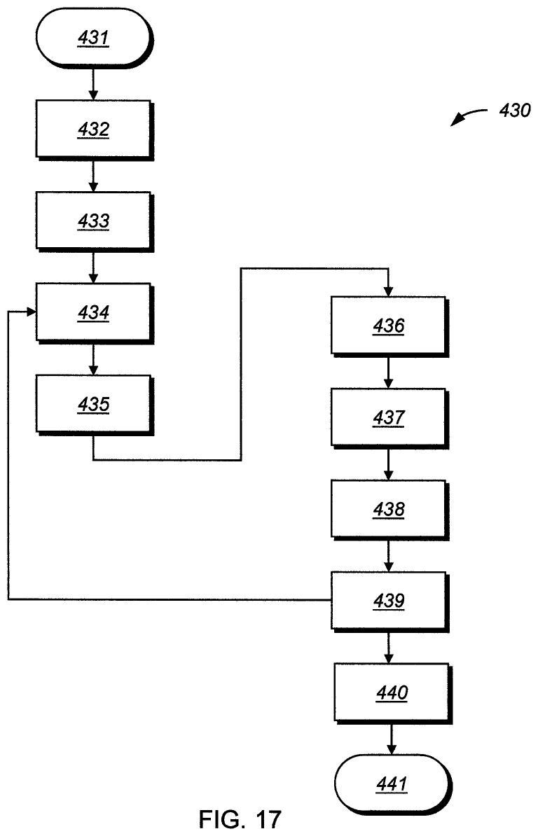

FIG. 17 illustrates an eighth example embodiment protocol 430, starting at method step 431 and continuing to method step 432, where protocol 430 may cause a protocol ready function to be performed. Protocol 430 continues to method step 433, where protocol 430 may cause linear actuator 56 to traction lower body support member 17 to a full prescribed length of extension, followed by protocol 430 holding linear actuator 56 at the full prescribed length of extension for a predetermined duration, for example 30 seconds. Next, protocol 430 proceeds to method step 434, where protocol 430 may cause linear actuator 56 to retract lower body support member 17 a predetermined length, for example ½ inch, followed by protocol 430 holding linear actuator 56 at this retracted length for a predetermined duration, for example 5 seconds. Protocol 430 then continues to method step 435, where protocol 430 may cause linear actuator 48 to extend or retract a predetermined length, thereby causing lower body support member 17 to rotate about pivot 71 in a predetermined direction to a predetermined angle, followed by protocol 430 holding linear actuator 48 at the predetermined length, thereby holding lower body support member 17 at the predetermined angle, for a predetermined duration, for example 5 seconds. In alternate embodiments, the predetermined direction may be either left or right, and the predetermined angle may be any angle which linear actuator 48 may rotate lower body support member 17 about pivot 71, for example 10 degrees or 20 degrees. Thereafter, protocol 430 proceeds to method step 436, where protocol 430 may cause linear actuator 56 to traction lower body support member 17 to a full prescribed length of extension, followed by protocol 430 holding linear actuator 56 at the full prescribed length of extension for a predetermined duration, for example 30 seconds. Continuing to method step 437, protocol 430 may next cause linear actuator 56 to retract lower body support member 17 a predetermined length, for example ½ inch, followed by protocol 430 holding linear actuator 56 at this retracted length for a predetermined duration, for example 5 seconds. Next, protocol 430 continues to method step 438, where protocol 430 may cause linear actuator 48 to return to a home position, thereby causing lower body support member 17 to rotate about pivot 71 to a centrally aligned orientation, followed by protocol 430 holding linear actuator 48 in the home position for a predetermined duration, for example 5 seconds. Proceeding thereafter to method step 439, where protocol 430 may cause linear actuator 56 to traction lower body support member 17 to a full prescribed length of extension, followed by protocol 430 holding linear actuator 56 at the full prescribed length of extension for a predetermined duration, for example 30 seconds. Method steps 434 through 439 may then be repeated by protocol 430 for a prescribed number of cycles, or for a predetermined duration. Protocol 430 then concludes by causing a protocol completion function to be performed at method step 440, with protocol 430 then ending at method step 441.

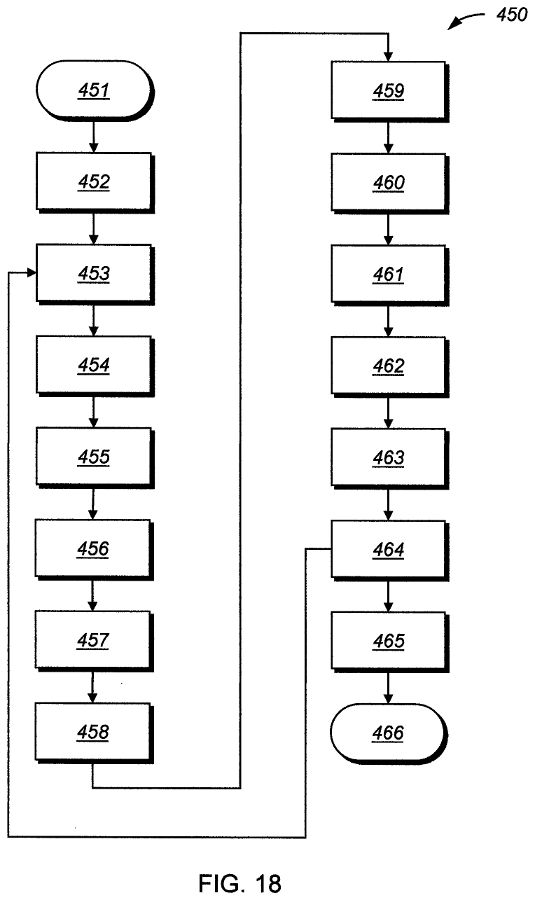

FIG. 18 illustrates a ninth example embodiment protocol 450, starting at method step 451 and continuing to method step 452, where protocol 450 may cause a protocol ready function to be performed. Protocol 450 continues to method step 453, where protocol 450 may cause linear actuator 56 to traction lower body support member 17 to a full prescribed length of extension, followed by protocol 450 holding linear actuator 56 at the full prescribed length of extension for a predetermined duration, for example 30 seconds. Next, protocol 450 proceeds to method step 454, where protocol 450 may cause linear actuator 56 to retract lower body support member 17 a predetermined length, for example ½ inch, followed by protocol 450 holding linear actuator 56 at this retracted length for a predetermined duration, for example 5 seconds. Protocol 450 then continues to method step 455, where protocol 450 may cause linear actuator 48 to extend or retract a predetermined length, thereby causing lower body support member 17 to rotate about pivot 71 in a predetermined direction to a predetermined angle, followed by protocol 450 holding linear actuator 48 at the predetermined length, thereby holding lower body support member 17 at the predetermined angle, for a predetermined duration, for example 5 seconds. In alternate embodiments, the predetermined direction may be either left or right, and the predetermined angle may be any angle which linear actuator 48 may rotate lower body support member 17 about pivot 71, for example 10 degrees or 20 degrees. Thereafter, protocol 450 proceeds to method step 456, where protocol 450 may cause linear actuator 56 to traction lower body support member 17 to a full prescribed length of extension, followed by protocol 450 holding linear actuator 56 at the full prescribed length of extension for a predetermined duration, for example 30 seconds. Continuing to method step 457, protocol 450 may next cause linear actuator 56 to retract lower body support member 17 a predetermined length, for example ½ inch, followed by protocol 450 holding linear actuator 56 at this retracted length for a predetermined duration, for example 5 seconds. Next, protocol 450 continues to method step 458, where protocol 450 may cause linear actuator 48 to return to a home position, thereby causing lower body support member 17 to rotate about pivot 71 to a centrally aligned orientation, followed by protocol 450 holding linear actuator 48 in the home position for a predetermined duration, for example 5 seconds. Proceeding thereafter to method step 459, where protocol 450 may cause linear actuator 56 to traction lower body support member 17 to a full prescribed length of extension, followed by protocol 450 holding linear actuator 56 at the full prescribed length of extension for a predetermined duration, for example 30 seconds. Protocol 450 then continues to method step 460, where protocol 450 may cause linear actuator 56 to retract lower body support member 17 a predetermined length, for example ½ inch, followed by protocol 450 holding linear actuator 56 at this retracted length for a predetermined duration, for example 5 seconds. Next, protocol 450 proceeds to method step 461, where protocol 450 may cause linear actuator 48 to retract or extend a predetermined length, thereby causing lower body support member 17 to rotate about pivot 71 in a predetermined direction to a predetermined angle, followed by protocol 450 holding linear actuator 48 at the predetermined length, thereby holding lower body support member 17 at the predetermined angle, for a predetermined duration, for example 5 seconds. In embodiments, the predetermined direction may be in a direction opposite of the predetermined direction of method step 414, and the predetermined angle may be the same angle as the predetermined angle of method step 414. Continuing to method step 462, protocol 450 may then cause linear actuator 56 to traction lower body support member 17 to a full prescribed length of extension, followed by protocol 450 holding linear actuator 56 at the full prescribed length of extension for a predetermined duration, for example 30 seconds. Proceeding next to method step 463, where protocol 450 may cause linear actuator 56 to retract lower body support member 17 a predetermined length, for example ½ inch, followed by protocol 450 holding linear actuator 56 at this retracted length for a predetermined duration, for example 5 seconds. Thereafter, protocol 450 proceeds to method step 464, where protocol 450 may next cause linear actuator 48 to return to a home position, thereby causing lower body support member 17 to rotate about pivot 71 to a centrally aligned orientation, followed by protocol 450 holding linear actuator 48 in the home position for a predetermined duration, for example 5 seconds. Method steps 453 through 464 may then be repeated by protocol 450 for a prescribed number of cycles, or for a predetermined duration. Protocol 450 then concludes by causing a protocol completion function to be performed at method step 465, with protocol 450 then ending at method step 466.

In embodiments, controller system 200 may be configured to provide a pause function, whereby a person operating or using the therapeutic apparatus may pause the performance of a protocol. When in the paused state, the person operating or using the therapeutic apparatus may adjust one or more configured parameters of the paused protocol, for example the current, configured or prescribed length of extension of linear actuator 25, 56, or 48 (or a pivot angle related thereto), independent of the protocol, or as an input to the protocol which may subsequently be applied by the protocol upon removing the protocol from the paused state.

The therapeutic apparatus may be configured with one or more physical mechanisms to immediately suspend or terminate any protocol which may be executing. In embodiments, the one or more physical mechanisms may disposed about the therapeutic apparatus in a location which may be readily accessible to a person operating or using the therapeutic apparatus. In embodiments, activation of the one or more physical mechanisms may cause power to the therapeutic apparatus, or controller system 200, to be shut off, and may also cause linear actuators 25, 56, or 48, to return to a first, minimal, or “home” position.

Controller system 200 may be configured to recognize, and adjust in response to, one or more levels of errors which may be encountered while performing or executing one or more protocols, which may be communicated to controller system 200 by one or more sensors disposed about the therapeutic apparatus, or one or more components thereof. For example, controller system 200 may be configured to recognize general errors or critical errors which may be encountered during operation of a protocol. In embodiments, a general error may comprise any error of operation which may not result in shutdown of controller system 200, whereas a critical error may be any error which may result in shutdown of controller system 200. In embodiments, controller system 200, or a device or application which may be in communication with controller system 200, may record or log any such errors which may be identified during operation, and for critical errors may cause shutdown of the therapeutic apparatus, or controller system 200, in the manner previously described, or for general errors may pause the current session or protocol and prompt a person operating or using the therapeutic apparatus to select to “continue” or “end” the current session or protocol.

Examples of errors which may be considered general may include failure to execute a command, controller system 200 not being calibrated, encountering an error during calibration, failure of an actuator or sensor, movement of an actuator in an incorrect direction, an inability of an actuator to extend to a minimum or maximum length of extension, a device not being positioned in a first, or home, position, an error in pausing or resuming operation of one or more components, an actuator meeting or exceeding a minimum or maximum position or length (or a pivot angle related thereto), or controller system 200 load cell inconsistency, floating, or falling outside boundary values. Examples of errors which may be considered critical errors may include a load cell of controller system 200 reading a state of error, or activation of the one or more physical mechanisms previously described which may be intended to suspend or terminate a performance or execution of a protocol.

In embodiments, during operation, one or more parameters or aspects of operation of one or more protocols being performed or executed may be presented to a person operating or using the therapeutic apparatus. In embodiments, these one or more parameters or aspects of operation may include, but not be limited to: the name, or type, of protocol being performed or executed, or a plurality or sequence thereof; the elapsed time, or time remaining, of the protocol or session being performed or executed, or a portion or sequence thereof; the current, configured, or prescribed length of extension of linear actuator 25, 56, or 48 (or a pivot angle related thereto); the current, configured, or prescribed magnitude or duration of vibration or heat being delivered by the therapeutic apparatus; or combinations thereof. In embodiments, such parameters may be presented on a display forming part of the therapeutic apparatus, or through a mobile device, a mobile application, or a web-based application configured to communicate with controller system 200.

As mentioned previously, in embodiments, controller system 200 may communicate with mobile device 220, on which mobile application 240 may be installed, and vice-versa, and mobile application 240 may communicate through mobile device 220 with web portal 260, or database 280, and vice-versa.

Web portal 260 may be any suitable web-based application which may be accessible through known internet browsing applications or web browsers. Web portal 260 may comprise one or more web-based user interfaces, and one or more databases 280 which may be accessible via the one or more user interfaces. Each of the one or more databases 280 may comprise one or more data tables, which may allow one or more data records to be created, stored, retrieved, updated, or deleted. In embodiments, web portal 260 and/or database 280 may be hosted on one or more processing platforms, for example one or more servers, which may be accessible via a suitable wired or wireless communications medium, or combinations thereof.

In embodiments, web portal 260 may be configured to require a person desiring access to web portal 260 to be authenticated prior to being granted access to interact with the one or more user interfaces, or create, store, retrieve, update, or delete the one or more data tables or data records of database 280. For example, web portal 260 may be configured to require each person being granted access to web portal 260 to be provided with a unique user name and a password known only to the person, and web portal 260 may be configured to authenticate a person by requiring that the person provide their user name and a password prior to being granted access to web portal 260, which web portal 260 may verify match a user name and password combination stored within web portal 260 or database 280 prior to granting the person access to web portal 260. In embodiments, web portal 260 may allow an authenticated person to continue to access web portal 260 until the authenticated person terminates the session during which they were granted access to web portal 260, or after a predetermined amount of time has elapsed during which web portal 260 may have determined the authenticated person may not be actively interacting with web portal 260.

In embodiments, database 280 may comprise a plurality of data tables. In an exemplary embodiment, database 280 may comprise a clinics data table, a locations data table, a users data table, a machines data table, a patients data table, and a passcodes data table. The clinics data table may comprise individual data fields for clinic name, street address, city, state, postal code, telephone, website, email address, and a logo of the clinic. The locations data table may comprise individual data fields for clinic name, location name, street address, city, state, postal code, and telephone. The users data table may comprise individual data fields for user name, user role, date of birth, telephone, email address, and an assigned clinic name. The machines data table may comprise individual data fields for machine type, machine name, an assigned clinic name, an assigned location name, and a media access control (MAC) address. In this manner, each data record of the machines data table may uniquely identify a therapeutic apparatus which may be physically present at the assigned clinic or the assigned location. The patients data table may comprise individual data fields for patient name, date of birth, gender, telephone, an assigned clinic name, and any medications the patient may be taking. The passcodes data table may comprise individual data fields for a passcode which may be required to be authenticated by web portal 260 prior to a person being granted access to a super user role or an administrative role which may be associated with one or more clinic data records or one or more location data records.

In embodiments, database 280 may also comprise a relational database management system (RDMS) which may be configurable to enforce minimum data requirements of one or more data records, or enforce data relationship requirements between or across one or more data tables or data records. In an exemplary embodiment, database 280 may be configured to require that each record of the clinics data table be populated with at least a clinic name, that each record of the locations table be populated with at least a clinic name, that each record of the users data table be populated with at least the user name, email address, and clinic name, that each record of the machines table be populated with all data fields, or that each record of the patients data table be populated with at least the patient name, date of birth, and assigned clinic name. The RDMS or web portal 260 may also be configured to enforce, for example, that at least one clinic data record is required, that at least one clinic data record is created before one location data record may be created, at least one clinic data record is created before one machine data record may be created, that the clinic name or email address of a user data record cannot be updated once the record is created, that the machine type, assigned clinic name, or assigned location of a machine data record cannot be updated once the machine data record is created, or that the assigned clinic name of a patient data record cannot be updated once the patient data record is created.

In embodiments, web portal 260 may be configured to allow one or more persons who may be granted access to web portal 260 to be assigned to one or more user roles, each of which may comprise differing levels of authorization to create, store, retrieve, update, or delete one or more data tables or data records. For example, web portal 260 may be configured to provide three roles, including a super user role, and administrative user role, and a general user role, and web portal 260 may be configured to require that a person being granted access to web portal 260 be assigned to one of these three roles.

In an exemplary embodiment, web portal 260 may be configured to limit an ability of a person to create, update, or delete a clinic data record to only persons assigned to the super user role. Similarly, web portal 260 may be configured to limit an ability of a person assigned to an administrative user role to add a user data record, assign a user role within a user data record, assign a clinic name or location name to a machine record, or access a patient data record to only data records assigned to the one or more clinic names to which the user may be associated. Within these or other such limitations, web portal 260 may be configured to present different user interfaces to a person authenticated to access web portal 260 based upon the authorizations associated with the authenticated user's assigned user role.

Web portal 260 may be configured to allow one or more data records to be imported into one or more data tables of database 280. In an embodiment, the ability to import data records may be limited based upon a user role. For example, the ability to import data records may be limited to persons assigned to the administrative user role, which based upon a configuration of web portal 260 previously described may further limit the ability to import data to only records relating to a clinic name to which a person assigned the administrative user role may be associated. In an embodiment, data records may be imported into the one or more data tables of database 280 via web portal 260 from any suitable data file format, for example a comma separated value (CSV) file format. For example, web portal 260 may be configured to allow a person assigned to the administrative user role to import patient data records into a patients data table of database 280 from a CSV file comprising the patient's name, date of birth, and gender, where the import may be limited to only the clinic names to which the person may be associated. Similarly, web portal 260 may be configured to allow a person assigned to the administrative user role to import user data records into a users data table of database 280 from a CSV file comprising the user's name, date of birth, and email address, where the import may be limited to only the clinic names to which the person may be associated.

Mobile application 240 may be any suitable application which may be locally installed on mobile device 220. In embodiments, mobile application 240 may be configured to require a person desiring access to interact with mobile application 240 to be authenticated prior to being granted access to interact with mobile application 240. For example, mobile application 240 may be configured to receive a user name and password from a person, which mobile application 240 may verify match a user name and password combination stored in web portal 260, database 280, or mobile application 240. In embodiments, mobile application 240 may allow an authenticated person to continue to access mobile application 240 until the person terminates the session during which they were granted access to mobile application 240, or after a predetermined amount of time has elapsed during which mobile application 240 may have determined the authenticated person may not be actively interacting with mobile application 240.

Mobile application 240 may be configured to require that a connection be established with each therapeutic apparatus intended to be controlled by mobile application 240. In embodiments, upon being authenticated to access mobile application 240, an authenticated user may select a clinic name or location name, obtained by mobile application 240 from web portal 260 or database 280 and which are associated with the authenticated user, where the authenticated user may be physically present. The selected clinic or location may then be stored by mobile application 240 as a current location. The authenticated user may then cause mobile application 240 to scan for therapeutic apparatuses which may be located within the range of the short-range networking capability of mobile device 220. Mobile application 240 may then display a listing of therapeutic apparatuses within range of mobile device 220 for which a connection has not yet been established with mobile application 240. Upon selecting a therapeutic apparatus from the listing, if the therapeutic apparatus is recorded in web portal 260 or database 280, for example in a machines data table, as being assigned to the current location, mobile application 240 will establish a connection with the selected therapeutic apparatus. If the selected therapeutic apparatus is not recorded in web portal 260 or database 280 as being assigned to the current location, then mobile application 240 may require that the therapeutic apparatus first be registered to the current location, which may be performed though web portal 260 by another person, for example a person authenticated to access web portal 260 who may be assigned to a super user role or an administrative user role.

Mobile application 240 may provide one or more user interfaces which may allow an authenticated person to view a listing of connected therapeutic apparatuses, or details of a single connected therapeutic apparatus which may include information regarding status of the therapeutic apparatus or information regarding an operational state of the therapeutic apparatus. In embodiments, a listing may display a list or grid view of one or more connected therapeutic apparatuses, which may further include for each therapeutic apparatus the type of the therapeutic apparatus, the name of the therapeutic apparatus, an image of the therapeutic apparatus, and an indication of the status of the therapeutic apparatus. In an embodiment, the status of each listed therapeutic apparatus may be displayed as a colored circle indicating whether the therapeutic apparatus may be in a ready state (for example, green), a running state (for example, blue), a paused state (for example, orange), an error state (for example, red), a calibrating state (for example, blue-green), an initiating state (for example, orange), or a not calibrated state (for example, red). Selecting a single therapeutic apparatus from a listing view may then display details of the selected therapeutic apparatus, or a user interface specific to the selected therapeutic apparatus. For example, mobile application 240 may provide an ability to modulate the selected therapeutic apparatus between a running and a pause state, and mobile application 240 may display information regarding progress of the running state, for example total time or time remaining, details of one or more protocols or configured parameters which may comprise aspects of the running state, or details of a person or patient who may be using the therapeutic apparatus. In another example, if the selected therapeutic apparatus is calibrating or in a state of error, mobile application 240 may display a message that the therapeutic apparatus is executing a calibration procedure or display details of an error detected by the therapeutic apparatus, respectively. In a further example, if the selected therapeutic apparatus is not calibrated, mobile application 240 may present a separate user interface which may allow the authenticated person to initiate calibration of the therapeutic apparatus.

Mobile application 240 may provide one or more user interfaces which may allow an authenticated person to cause a treatment command to execute on a selected therapeutic apparatus. As used herein, a “treatment” or “treatments” may comprise one or more protocols, each of which may further comprise one or more configured parameters, and “treatment command” may comprise one or more instructions which may be communicated from mobile application 240 to controller system 200 of a therapeutic apparatus in order to provide the treatment or treatments to the therapeutic apparatus. In embodiments, mobile application 240 may be configured to require that the selected therapeutic apparatus is in a status ready to accept a treatment command, which may comprise the therapeutic apparatus having first been calibrated. Mobile application 240 may also be configured to require that an authenticated person first select a patient and create a treatment command before sending a treatment command to the selected therapeutic apparatus to be executed.

In embodiments, mobile application 240 may allow an authenticated user to view a listing of patients, or a history of treatments which are associated with an individual patient, each of which may be recorded by web portal 260, database 280, or mobile application 240. Each entry in a history of treatments for a patient may comprise a date the treatment was performed, a listing of one or more protocols comprising the treatment, a listing of one or more configurations associated with each of the one or more protocols, a duration of each of the one or more protocols comprising the treatment, a name of the therapeutic apparatus on which the treatment was executed, and a name of an authenticated person who caused the treatment to be executed. An authenticated person may select a patient, following which mobile application 240 may cause a user interface to be updated to reflect that the patient selection requirement has been fulfilled. For example, once a patient is selected, mobile application 240 may change the color of a user interface element for selecting a patient, and may cause a user interface element for selecting a treatment to become accessible to the authenticated user.

In embodiments, mobile application 240 may allow an authenticated user to create a treatment command and send the treatment command to a selected therapeutic device for execution. In such embodiments, mobile application 240 may allow an authenticated user to view a listing of one or more protocols which may be performed at the therapeutic device, which may include, for example, protocols 340, 350, 370, 380, 390, 410, 420, 430, 450, or other suitable protocols. The authenticated user may then select one or more desired protocols to perform, which upon selecting, mobile application 240 may display a user interface which may allow the authenticated user to configure one or more parameters related to any of the protocols to be included in the treatment command, for example a length of extension of linear actuator 25, 56, or 48, which may comprise a prescribed length of extension, a direction or angle which linear actuator 48 may cause lower body support member 17 to rotate about pivot 71, which may comprise a prescribed direction or angle, one or more durations of time during which a length of extension of linear actuator 25, 56, or 48, or an angle of rotation of lower body support member 17 about pivot 71, may be held, or a duration of time during which one or more protocols may be performed, any of which may comprise one or more prescribed durations of time. Upon the authenticated user having configured the one or more parameters, or accepting default configurations of the one or more parameters, mobile application 240 may display the selected protocol(s) and/or the configurations of the one or more parameters to the authenticated user for review and acceptance, at which time mobile application 240 may also present one or more user interface elements allowing the authenticated user to adjust or accept the selected protocol, the one or more configured parameters, or various combinations or sequences thereof. In embodiments, the selected protocol and the one or more configured parameters may comprise a treatment command to be transmitted to the selected therapeutic device.

Upon being accepted by the authenticated user, mobile application 240 may cause a treatment command to be created and prepared for transmission to control system 200, at which time mobile application 240 may also cause a user interface element for selecting a treatment to change appearance, thereby indicating to the authenticated user that the treatment command is ready to be transmitted to the selected therapeutic device. The authenticated user may then select to “start” the treatment command through a user interface of mobile application 240, at which time mobile application 240 may transmit the treatment command to controller system 200 of the selected therapeutic apparatus for execution. At this time, mobile application 240 may provide a user interface which may display one or more aspects of operation related to the execution of the treatment command, or protocol thereof, in the manner previously described. At this time, mobile application 240 may also communicate one or more aspects of the treatment command to web portal 260 to be recorded in database 280, along with one or more aspects of the operation of the treatment command, for example “started,” “completed,” or “error,” based upon the progress of execution of the treatment command.

Although the present invention and its advantages have been described in detail, it should be understood that various changes, substitutions and alterations may be made herein without departing from the spirit and scope of the invention as defined by the appended claims.

What is claimed is:

1. A reclinable therapeutic massage chair, comprising:
a floor support assembly;
a chair support frame pivotably attached to the floor support assembly;
an upper back support mounted on the chair support frame;
a pair of underarm supports mounted on the chair support frame;
a lower body support member having a lower back support surface, a thigh support surface and a lower leg support surface, said lower body support member being mounted for both reciprocal and rotational movement in a same plane on the chair support frame, said rotational movement being about a pivot oriented perpendicular to the plane;
a first linear actuator for providing pivoting movement of the chair support frame from an inclined position to a horizontal position;
a second linear actuator for providing reciprocal movement of the lower body support member;
a third linear actuator for providing rotational movement of the lower body support member; and
a controller system, said controller system for providing control of the first linear actuator, the second linear actuator, the third linear actuator, or combinations thereof.

2. The reclinable therapeutic massage chair of claim 1, wherein the controller system comprises a power supply, a microcontroller, one or more load cells, one or more load cell amplifiers, one or more motor drivers, or one or more position feedback systems, or combinations thereof.

3. The reclinable therapeutic massage chair of claim 2, wherein the controller system is operated wirelessly from a mobile application, said mobile application operating on a mobile device, said mobile device comprising any device capable of mobility on which the mobile application may be installed.

4. The reclinable therapeutic massage chair of claim 3, wherein the controller system communicates with the mobile device via a wireless networking medium.

5. The reclinable therapeutic massage chair of claim 3, wherein the mobile application communicates with a web-based portal via a network communications medium, said web-based portal comprising a user interface, a database, or combinations thereof.

6. The reclinable therapeutic massage chair of claim 1, wherein the controller system performs a calibration function to calibrate the movement provided by the first linear actuator, the second linear actuator, the third linear actuator, or combinations thereof.

7. The reclinable therapeutic massage chair of claim 1, wherein the first linear actuator, the second linear actuator, the third linear actuator, or combinations thereof, are controlled by one or more protocols performed by the controller system, said one or more protocols comprising a protocol ready function, a protocol completion function, or combinations thereof.

8. The reclinable therapeutic massage chair of claim 7, wherein the protocol ready function causes the first linear actuator to return to a home position.

9. The reclinable therapeutic massage chair of claim 7, wherein the protocol completion function causes the first linear actuator, the second linear actuator, or the third linear actuator, or combinations thereof, to return to a home position and pause for a duration of time after being returned to the home position.

10. The reclinable therapeutic massage chair of claim 7, wherein the one or more protocols:
cause the second linear actuator to extend or retract the lower body support member all of, or one or more portions of, a prescribed length of extension;
cause the third linear actuator to rotate the lower body support member all of, or one or more portions of, a prescribed angle of rotation in either a clockwise or counter-clockwise direction;
cause the second linear actuator to hold a length of extension for a prescribed or predetermined duration of time;
cause the third linear actuator to hold an angle of rotation for a prescribed or predetermined duration of time;
cause actuation of, a hold in the actuation of, or one or more sequences of actuation and a hold in actuation of, the second linear actuator, the third linear actuator, or combinations thereof, to be cycled;
or combinations thereof.

11. A controller system for controlling a therapeutic device, comprising:
a therapeutic device;
a controller system, comprising:
a microcontroller;
a mobile device coupled to the microcontroller by a wireless networking medium;
a mobile application operating on the mobile device, said mobile application in communication with the microcontroller;
wherein the controller system is configured to control actuation of one or more movements of the therapeutic device; and
wherein the therapeutic device comprises a reclinable therapeutic massage chair.

12. The controller system of claim 11, wherein the therapeutic device comprises a plurality of therapeutic devices.

13. The controller system of claim 11, wherein the mobile application requires a person to be authenticated before the person is allowed to access one or more user interfaces of the mobile application.

14. The controller system of claim 11, wherein the mobile application provides one or more user interfaces which allow a person to configure one or more parameters of operation of the therapeutic device.

15. The controller system of claim 11, wherein the mobile application provides one or more user interfaces which allow a person to configure one or more sequences of operation of the therapeutic device.

16. The controller system of claim 11, wherein the mobile application provides one or more user interfaces which allow a person to pause or stop operation of the therapeutic device.

17. The controller system of claim 11, further comprising a web-based portal, wherein the mobile application is in communication with said web-based portal.

18. The controller system of claim 17, wherein the web-based portal comprises one or more user interfaces, one or more databases, or combinations thereof.

19. The controller system of claim 18, wherein the one or more databases comprise one or more data tables for storing one or more records, said records comprising one or more fields of information identifying a clinic, a location, a user, a machine, a patient, a passcode, or combinations thereof.

20. The controller system of claim 19, wherein the machine comprises the therapeutic device.
